(19) United States
(12) Patent Application Publication
(10) Pub. No.: US 2014/0204163 A1
(43) Pub. Date: Jul. 24, 2014

(54) METHOD TO REDUCE SKEW IN ROLL-BASED MEDIA

(71) Applicant: HEWLETT-PACKARD DEVELOPMENT COMPANY, LP., Houston, TX (US)

(72) Inventors: Hugo Ortiz, Vancouver, WA (US); Bruce G. Johnson, Vancouver, WA (US)

(73) Assignee: HEWLETT-PACKARD DEVELOPMENT COMPANY, L.P., Houston, TX (US)

(21) Appl. No.: 13/746,062

(22) Filed: Jan. 21, 2013

(51) Int. Cl. B65H 23/02; B41J 15/16

(52) U.S. Cl. CPC B65H 23/02; B41J 15/16
USPC 347/104; 226/3

(57) ABSTRACT

A method for reducing media skew in a media advance mechanism according to embodiments of the invention includes applying tension to a roll of media in a direction that opposes forward motion of the media, advancing the media, and reversing the media.

### TECHNICAL FIELD

The present disclosure is related to a method to reduce skew in roll-based media in a media advance mechanism.

### BACKGROUND

A number of devices are provided with a media advance mechanisms for causing a media such as paper, fabric, cardboard or the like to advance through the apparatus in order to perform some operation on the media. The media advance mechanism of an inkjet printer, for example, causes a printing media such as a sheet or web of paper, textile or other substrate to travel in an advance direction through a print zone, where a printhead deposits ink on the media in either successive swaths or using a wide page array.

Accurate positioning of the media when the media is fed to a printer is necessary, especially when working with a web of media, since skew of the media when the leading edge is fed to the printer may lead to an increasing media positioning error as the media advances through the printer, with the risk of causing errors in the position of the dots of ink ejected by the printhead, and thus print defects and/or poor print quality.

### BRIEF DESCRIPTION OF THE DRAWINGS

In the drawings:

FIG. 1 is a schematic drawing showing in cross section the arrangement of some elements of a media advance mechanism;

FIG. 2 is a flowchart of a method for reducing skew in a media advance mechanism in one example of the present disclosure;

FIG. 3 is a flowchart of one example of applying tension; and

FIG. 4 is a flowchart of a method for reducing skew in a media advance mechanism in one example of the present disclosure.

### DETAILED DESCRIPTION

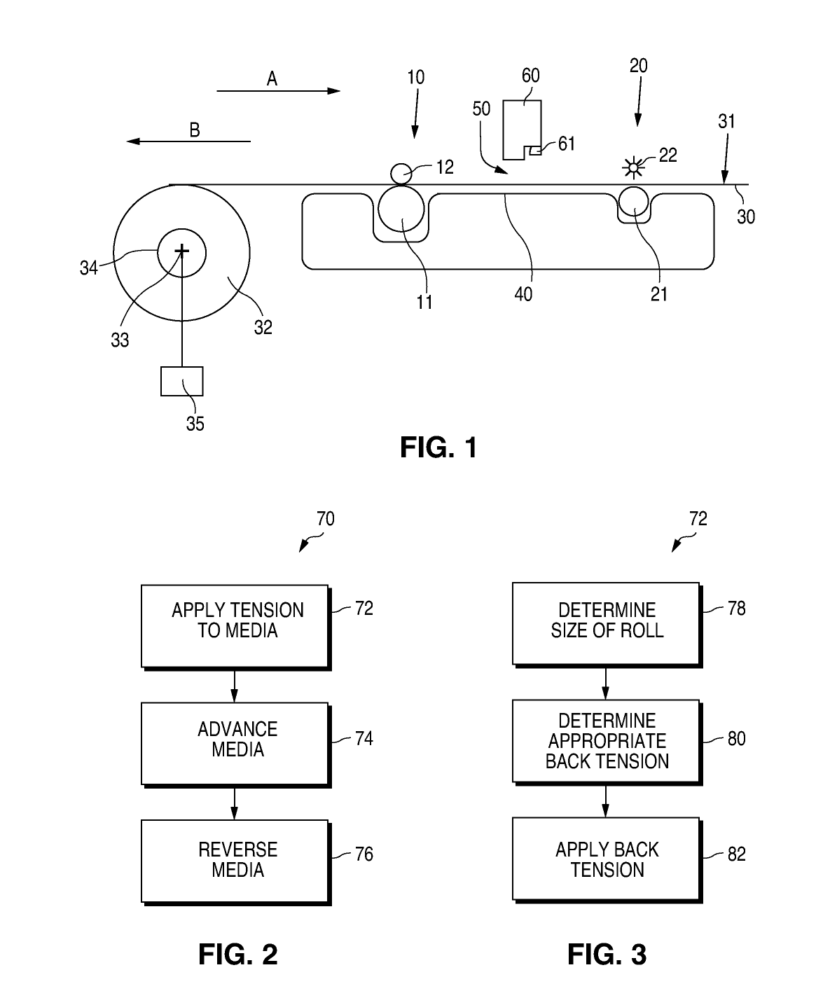

In FIG. 1, a media advance mechanism of a printer comprises an input driving device 10 and an output driving device 20 for driving the print media 30 through the printer, usually on a platen 40, in a media advance direction A. The input driving device 10 is arranged at the media inlet of the printer, upstream of a print zone 50 where ink is deposited on the media from a print head 60, while the output driving device 20 is arranged downstream of the print zone 50.

The input driving device 10 may comprise for example a grit roller 11 and a plurality of pinch rollers 12 spanning the width of the media 30, the media being engaged between the grit roller 11 and the pinch rollers 12, while in the output driving device 20 or overdrive the media is engaged between several sets of rubber rollers 21 and star wheels 22, placed at intervals across the width of the media, with the rubber rollers 21 underneath the media and the star wheels 22 in contact with the printed surface 31. Any suitable structures may be used for input driving device 10 and output driving device 20.

The media 30 may be a web of paper or other print substrate which is held on a roll 32 arranged about an axis 33. In use, the roll may be mounted on a spindle 34 or the like, and the spindle 34 is inserted in appropriate supports (not shown) of the printer. Spindle 34 is attached to a structure 35 for creating back tension in media 30, tension that resists the forward media direction A. Back tension structure 35 may be, for example, a drag or friction clutch that creates friction on spindle 34, or a servomotor paired with an encoder that can behave as a variable clutch. The input driving device 10, output driving device 20, and/or back tension structure 35 may also reverse the media in reverse direction B.

When a new media roll is loaded in the printer, the user feeds the leading edge of the media to the input driving device 10, which drives it forward through the printer until the edge of the media reaches and engages the outlet driving device 20, and travels a distance past the outlet device 20. At this point the media is engaged in the advance mechanism of the printer, but it may have a certain degree of skew.

Skew may be measured at this point. For example, a sensor 61 such as an optical sensor may be mounted on the carriage that supports print head 60. Sensor 61 may detect the position of media 30. Media 30 is then advanced and the sensor 61 again detects the position of media 30. The difference in position is the skew. In devices where a page wide array pen configuration is used, skew can alternatively be measured with a stationary sensor array.

If the measured skew is below a predetermined lower skew limit, then no correction is required. If the measured skew is above a predetermined upper skew limit, then a skew correction method is performed. If after a defined number of skew correction attempts the skew is still greater than a predetermined upper skew limit, the loading operation fails and the user is instructed to remove the media from the printer and load it again. The lower and upper skew limits may depend for example on the kind of media. In some implementations, a skew correction method may be implemented without first determining the skew.

FIG. 2 is a flowchart of a method 70 for reducing media skew in one example of the present disclosure. Method 70 begins in block 72. In block 72, tension is applied to the media. The tension applied in block 72 opposes the forward or advance motion of the media.

If the media is not properly aligned when tension is applied, the tension across the media is not consistent across the media (i.e. from left to right). Block 72 is followed by block 74. In block 74, the media is advanced. Block 74 is followed by block 76. In block 76, the media is reversed. When the media is advanced in block 74, the side of the media with the higher back tension will underfeed relative to the opposite side, while the side of the media with the lower back tension will overfeed relative to the opposite side. When the media is reversed in block 76, the side with the higher back tension will overfeed relative to the opposite side and the side with the lower back tension will underfeed relative to the opposite side. The differential feeding of one side relative to the other brings the back tension on both sides to equilibrium, thereby reducing the skew in the media.

The tension applied in block 72 may be applied by any suitable structure including, for example, a friction clutch connected to spindle 34 or a servomotor connected to spindle 34, as described above in reference to FIG. 1. A friction clutch imparts constant torque to spindle 34, regardless of media type or roll diameter. In implementations that apply tension with a servomotor, the amount of torque applied to spindle 34 may vary. FIG. 3 illustrates a method 72 of applying tension in implementations using a servomotor. In block 78, the size of the media roll is determined. Lower tension may be needed for a smaller diameter roll in some examples. In some examples, an encoder coupled to the drive system that applies the tension monitors the feed shaft that advances the media. Based on the distance of media advanced and knowing the number of encoder counts associated with the advance distance, the diameter of the roll can be determined. Alternatively, the size of the media roll may be determined by, for example, measuring the diameter of the roll. In block 80, the amount of tension appropriate to the roll size is determined. In block 82, the tension determined in block 80 is applied to the media roll.

The amount of tension applied may differ for different types of media. For example, lower tension may be applied to delicate media such as coated photo medias as compared to more robust media such as plain paper. Higher back tension may result in greater slippage on the grit roller, as described below, and thus may potentially damage the surface of delicate media. In some examples, when a new roll of media is loaded, the user is prompted to define the type of media.

The amount of tension applied may also differ for different widths of media. In some examples, the width of the media is measured, for example using the sensor 61 on print head 60, described above in the text accompanying FIG. 1. The media width and the user-defined media type may be used, for example by an encoder coupled to the servomotor, to determine the appropriate tension.

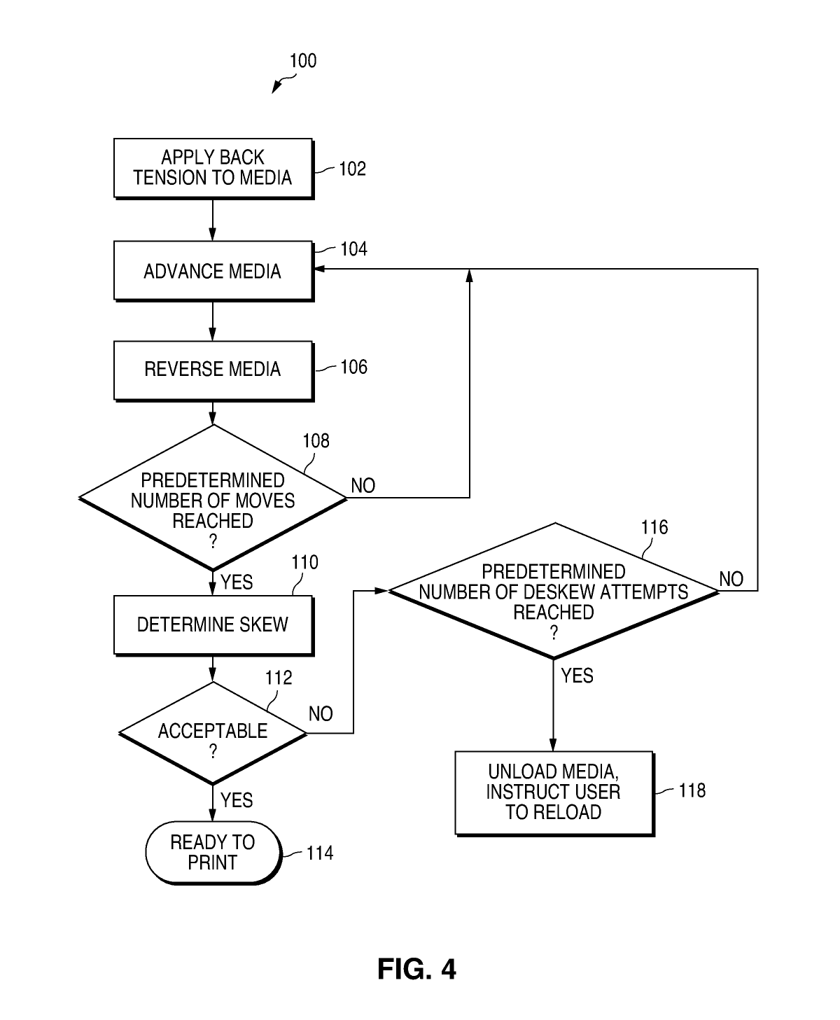

FIG. 4 is a flowchart of a method 100 for reducing media skew in one example of the present disclosure. In block 102, back tension is applied to the media. In block 104 the media is advanced. In block 106 the media is reversed. At block 108, if a predetermined number of forward and backward moves of the media has not yet been reached, the method returns to block 104. If a predetermined number of forward and backward moves of the media has been reached, the skew is determined in block 110. If the skew is acceptable, the media has been sufficiently deskewed. If the media advance mechanism is part of a printer, the printer is ready for printing in block 114. If the skew is not acceptable, the method advances to block 116. If a predetermined number of deskew attempts has not yet been reached in block 116, the method returns to block 104 and again attempts to deskew the media. If a predetermined number of deskew attempts has been reached, in block 118 the media is unloaded from the media advance system and the user may be instructed to reload the media.

In some implementations, sufficient back tension may be applied to cause the media to slip on grit roller during the advancing in block 74 of FIG. 2 or block 104 of FIG. 4. Slippage may reduce the number of iterations of advancing and reversing required to bring the back tension on both sides of the media to equilibrium.

Once the skew is reduced to an acceptable level, in implementations where the media advance mechanism is incorporated into a printer, the media is ready to be printed upon. In some implementations, the amount of back tension applied to the media is reduced after skew reduction and prior to printing.

The methods described herein have the advantage of not relying on a user to reduce skew. For example, the ability to use a device including the media advance mechanism capable of the methods described herein does not depend on the user's ability to load media with minimal skew or to readjust media to remove skew after loading.

Various other adaptations and combinations of features of the examples disclosed are within the scope of the invention. The present disclosure describes an example of a media advance mechanism. The methods to reduce skew described by the present disclosure may be used with other media advance mechanisms, or with other systems that require alignment of media. Numerous examples are encompassed by the following claims.

What is claimed is:

1. A method for reducing media skew in a media advance mechanism, the method comprising:
applying tension to a roll of media in a direction that opposes forward motion of the media;
advancing the media; and
reversing the media.

2. The method of claim 1, further comprising advancing and reversing the media a predetermined number of times.

3. The method of claim 1, further comprising determining the skew after advancing and reversing the media.

4. The method of claim 1, further comprising reducing the tension applied to the roll of media after advancing and reversing the media.

5. The method of claim 4, further comprising printing on the media after reducing the tension applied.

6. The method of claim 1, wherein:
advancing the media comprises rolling the media between two rollers; and
applying tension to a roll of media in a direction that opposes forward motion of the media comprises applying sufficient tension that the media slips on one of the rollers during said advancing the media.

7. The method of claim 1, wherein applying tension to a roll of media in a direction that opposes forward motion of the media comprises engaging a servomotor connected to a spindle on which the roll of media is mounted.

8. The method of claim 1, further comprising determining a radius of the roll of media and determining an amount of tension to be applied based on the radius of the roll.

9. A method for reducing media skew in a media advance mechanism, the method comprising:
feeding media from a media roll mounted on a spindle through an input driving device and an output driving device;
applying back tension to the media roll;
after applying back tension, alternately advancing and reversing the media through the input driving device and the output driving device; and
determining the skew.

10. The method of claim 9, further comprising:
after alternately advancing and reversing the media, reducing the applied back tension; and
after reducing the applied back tension, printing on the media.

11. The method of claim 9, further comprising:
determining the skew after alternately advancing and reversing the media a predetermined number of times; and
alternatively advancing and reversing the media if the determined skew is higher than a predetermined maximum skew.

12. The method of claim 9, wherein applying back tension to the media roll comprises engaging a clutch on the spindle.
